(19) United States
(12) Patent Application Publication
(10) Pub. No.: US 2026/0188692 A1
(43) Pub. Date: Jul. 2, 2026

(54) ELECTRODE LAMINATE AND METHOD FOR MANUFACTURING ELECTRODE LAMINATE

(71) Applicant: TOYOTA JIDOSHA KABUSHIKI KAISHA, Aichi-ken (JP)

(72) Inventors: Masato ONO, Nagoya-shi (JP); Tadashi TERANISHI, Toyota-shi (JP); Yusuke OISHI, Toyota-shi (JP); Tomofumi HIRUKAWA, Miyoshi-shi (JP); Yosuke SHIMURA, Nagakute-shi (JP); Hiroshi KAWASAKI, Toyota-shi (JP); Katsuhisa TSUZUKI, Toyota-shi (JP); Takashi IZU, Kashiba-shi (JP)

(21) Appl. No.: 19/428,303

(22) Filed: Dec. 22, 2025

(30) Foreign Application Priority Data
Dec. 27, 2024 (JP) 2024-232576

(51) Int. Cl. H01M 4/66; H01M 4/04; H01M 4/70

(52) U.S. Cl. CPC H01M 4/663; H01M 4/0404; H01M 4/0471; H01M 4/667; H01M 4/70

(57) ABSTRACT

An electrode laminate includes: a current collector layer; and an electrode active material layer laminated on a part of the current collector layer. The current collector layer includes an electric conductor layer, and a first carbon coat layer laminated in at least a part of a region of the electric conductor layer, the electrode active material layer is laminated on at least a part of the first carbon coat layer, and, in an adjacent region being adjacent to the electrode active material layer, the current collector layer does not include the first carbon coat layer, or includes a second carbon coat layer having lower absorptivity of laser light having a wavelength of 970 nm than that of the first carbon coat layer.

### FIELD

The present disclosure relates to an electrode laminate and a method for manufacturing an electrode laminate.

### BACKGROUND

It has been known that a carbon coat layer is laminated between a current collector layer and an electrode active material layer included in an electrode laminate for the purpose of reducing internal resistance. Various disclosures of a configuration of the carbon coat layer have been made.

PTL 1 discloses a current collecting foil including a metal foil, a carbon coat layer that is laminated on a foil surface of the metal foil and includes carbon particles, and an active material layer that is laminated on a layer surface of the carbon coat layer and includes an active material, and the carbon coat layer has surface roughness Ra of the layer surface of 0.5 μm to 1.0 μm. In PTL 1, according to the disclosure of PTL 1, occurrence of interface peeling between the carbon coat layer and the active material layer of the current collecting foil can be suppressed, and a battery characteristic can also be improved.

PTL 2 discloses a carbon coat layer provided on a current collector, and protrusions and recesses of a carbon material are provided on a side in contact with an active material. In PTL 2, according to the disclosure of PTL 2, by forming the protrusions and recesses of the carbon material on the current collector, adhesion between the active material and the current collector can be improved without a loss of a filling volume of the active material, internal resistance can be reduced, and a characteristic excellent in a charge/discharge cycle can be acquired without lowering capacity of a battery.

Meanwhile, laser irradiation has been known as methods for drying and molding an electrode composite material slurry layer applied onto a current collector layer. Particularly, drying of electrode slurry by the laser irradiation has characteristics of lower energy consumption and a lower environmental load than drying by hot air.

PTL 3 discloses an electrode shape control method including a molding stage of molding a shape of electrode slurry by irradiating, with a laser, at least a part of an electrode sheet coated with the electrode slurry, and moving the electrode slurry of the portion irradiated with the laser to an adjacent portion. In PTL 3, according to the disclosure of PTL 3, the electrode shape control method and an electrode manufacturing method that can minimize a capacity loss while controlling a shape of an electrode after electrode coating can be provided.

PTL 4 discloses an electrode body manufacturing method that includes a conveyance step of conveying an electrode body coated with at least one electrode material by a conveyance unit, and a drying step of drying the electrode material while conveying the electrode body by the conveyance unit. The drying step includes an irradiation step of drying the electrode material by irradiating the electrode material with a laser when the electrode body is conveyed to at least one first position in a conveyance direction of the conveyance unit. The drying step includes a collection step of collecting vapor generated due to irradiation of the electrode material with the laser by a steam collection unit provided in at least one second position adjacent to the first position in the conveyance direction. In PTL 4, according to the disclosure of PTL 4, a decrease in drying efficiency can be suppressed when an electrode material is dried by a laser.

### CITATION LIST

### Patent Literature

[PTL 1] Japanese Unexamined Patent Publication (Kokai) No. 2010-212167
[PTL 2] Japanese Unexamined Patent Publication (Kokai) No. 2015-088333
[PTL 3] Japanese Unexamined Patent Application Publication (Translation of PCT Application) No. 2024-518633
[PTL 4] Japanese Unexamined Patent Publication (Kokai) No. 2023-169591

### SUMMARY

### Technical Problem

An electrode laminate is manufactured by coating a carbon coat layer included in a current collector layer with electrode composite material slurry, and heating and drying the electrode composite material slurry by light irradiation such as laser irradiation. When the light irradiation is performed on the electrode composite material slurry, it is difficult to perform the light irradiation on only the electrode composite material slurry, and the adjacent carbon coat layer is also subjected to the light irradiation. The carbon coat layer has high light absorptivity and is thus raised to a high temperature, and the heat is transferred to an end portion of the electrode composite material slurry. In this way, as a result of an increase in an evaporation speed of a volatile substance in the electrode composite material slurry, vapor pressure in the electrode composite material slurry increases, and a crack is more likely to be generated in an electrode active material layer formed by drying. Therefore, the electrode laminate in which a brittle fracture is more likely to occur is acquired.

Thus, the present disclosure has an objective to provide an electrode laminate in which a brittle fracture is less likely to occur.

### Solution to Problem

The present disclosure achieves the objective described above by the following means.

### Aspect 1

An electrode laminate includes:
a current collector layer; and an electrode active material layer laminated on a part of the current collector layer, wherein
the current collector layer includes an electric conductor layer, and a first carbon coat layer laminated in at least a part of a region of the electric conductor layer,
the electrode active material layer is laminated on at least a part of the first carbon coat layer, and,
in an adjacent region being adjacent to the electrode active material layer, the current collector layer does not include the first carbon coat layer, or includes a second carbon coat layer having lower absorptivity of laser light having a wavelength of 970 nm than that of the first carbon coat layer.

### Aspect 2

The electrode laminate according to aspect 1, wherein the electrode active material layer is laminated on only a part of the first carbon coat layer.

### Aspect 3

The electrode laminate according to aspect 1 or 2, wherein the first carbon coat layer on which the electrode active material layer is not laminated is disposed on a peripheral portion of the current collector layer.

### Aspect 4

The electrode laminate according to any one of aspects 1 to 3, wherein, in the adjacent region, absorptivity of laser light having a wavelength of 970 nm of the current collector layer is 40% or less.

### Aspect 5

A method for manufacturing the electrode laminate according to any one of aspects 1 to 4 includes:
laminating an electrode composite material slurry layer on at least a part of the first carbon coat layer; and
irradiating, with laser light, the electrode composite material slurry layer laminated on at least a part of the first carbon coat layer, and the adjacent region, drying the electrode composite material slurry layer, and forming an electrode active material layer.

### Advantageous Effects of Invention

According to the present disclosure, an electrode laminate in which a brittle fracture is less likely to occur can be provided.

### BRIEF DESCRIPTION OF DRAWINGS

FIG. 1A is a front cross-sectional view illustrating an electrode laminate according to the present disclosure.

FIG. 1B is a front cross-sectional view illustrating an electrode laminate according to the present disclosure.

FIG. 2A is a top view illustrating the electrode laminate according to the present disclosure.

FIG. 2B is a top view illustrating the electrode laminate according to the present disclosure.

FIG. 3A is a schematic diagram illustrating Examples and Comparative Example.

FIG. 3B is a schematic diagram illustrating Examples and Comparative Example.

FIG. 3C is a schematic diagram illustrating Examples and Comparative Example.

FIG. 3D is a schematic diagram illustrating Examples and Comparative Example.

FIG. 3E is a schematic diagram illustrating Examples and Comparative Example.

FIG. 4A is a schematic diagram illustrating Examples and Comparative Example.

FIG. 4B is a schematic diagram illustrating Examples and Comparative Example.

FIG. 4C is a schematic diagram illustrating Examples and Comparative Example.

FIG. 4D is a schematic diagram illustrating Examples and Comparative Example.

FIG. 4E is a schematic diagram illustrating Examples and Comparative Example.

### DESCRIPTION OF EMBODIMENTS

### <<Electrode Laminate>>

An electrode laminate according to the present disclosure includes:
a current collector layer; and an electrode active material layer laminated on a part of the current collector layer, wherein
the current collector layer includes an electric conductor layer, and a first carbon coat layer laminated in at least a part of a region of the electric conductor layer,
the electrode active material layer is laminated on at least a part of the first carbon coat layer, and,
in an adjacent region being adjacent to the electrode active material layer, the current collector layer does not include a carbon coat layer, or includes a second carbon coat layer having lower absorptivity of laser light having a wavelength of 970 nm than that of the first carbon coat layer.

According to the present disclosure, the electrode laminate in which a brittle fracture is less likely to occur can be provided.

In a case where the carbon coat layer is not included in the adjacent region, or the carbon coat layer having high reflectivity is included in the adjacent region, the adjacent region is not overheated even when light energy is supplied to the adjacent region together with the electrode composite material slurry at the time of drying of the electrode composite material slurry, and heat transfer to an end portion of the electrode composite material slurry is suppressed. Therefore, cracking does not occur in the electrode active material layer, and the electrode laminate in which a brittle fracture is less likely to occur is acquired.

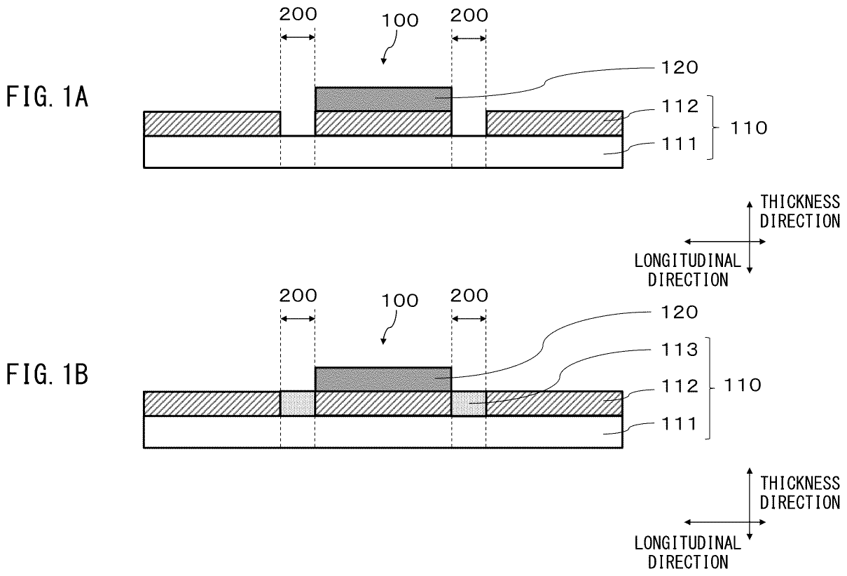

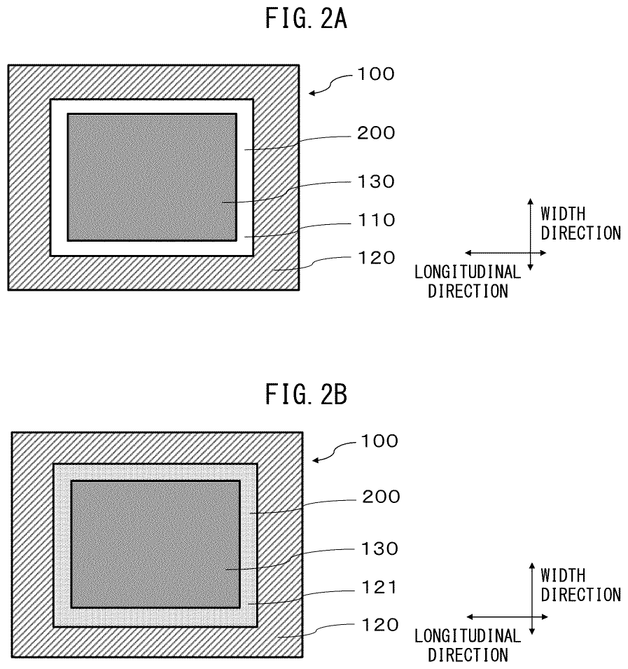

Specifically, for example, as in FIG. 1A, an electrode laminate 100 according to the present disclosure includes a current collector layer 110, and an electrode active material layer 120 laminated on a part of the current collector layer 110. Herein, the current collector layer 110 includes an electric conductor layer 111 and a first carbon coat layer 112, and the first carbon coat layer 112 is laminated on a part of the electric conductor layer 111. Then, the electrode active material layer 120 is laminated on a part of the first carbon coat layer 112. The first carbon coat layer 112 is not laminated on the electric conductor layer 111 in an adjacent region 200 of the electrode active material layer 120. Further, as in FIG. 1B, a second carbon coat layer 113 having low laser light absorptivity may be laminated on the electric conductor layer 111 in the adjacent region 200. Note that FIG. 2A is a top view of FIG. 1A, and FIG. 2B is a top view of FIG. 1B.

Embodiments according to the present disclosure will be described below in detail. Note that the present disclosure is not limited to the embodiments below, and can be implemented while various modifications are made within the scope of the purpose of the present disclosure.

The electrode laminate according to the present disclosure includes the current collector layer, and the electrode active material layer laminated on a part of the current collector layer. Further, the electrode laminate may be a bipolar electrode laminate including a positive electrode active material layer and a negative electrode active material layer.

The electrode active material layer is laminated on at least a part of a first carbon coat layer. The electrode active material layer is laminated on the carbon coat layer, and thus internal resistance can be reduced. Note that the electrode active material layer may be laminated on only a part of the first carbon coat layer.

### <Current Collector Layer>

The current collector layer includes an electric conductor layer, and a carbon coat layer laminated in at least a part of a region of the current collector layer.

In an adjacent region being adjacent to the electrode active material layer, the current collector layer does not include the first carbon coat layer, or includes a second carbon coat layer having lower absorptivity of laser light having a wavelength of 970 nm than that of the first carbon coat layer.

In the present specification, as illustrated in FIGS. 1 and 2, the “adjacent region” means a region outside the electrode active material layer within 10 mm, 20 mm, 30 mm, 40 mm, 50 mm, or 100 mm from an end portion of the electrode active material layer in a longitudinal direction and a width direction of the electrode active material layer, and also means a region adjacent to the electrode active material layer.

In the adjacent region, absorptivity of laser light having a wavelength of 970 nm of the current collector layer may be 40% or less. Further, absorptivity of laser light having a wavelength of 970 nm of the current collector layer may be 35% or less, 30% or less, 25% or less, or 20% or less, and 0% or more, 5% or more, 10% or more, or 15% or more.

The first carbon coat layer on which the electrode active material layer is not laminated may be disposed on a peripheral portion of the current collector layer. When a storage module for a bipolar battery is constituted by laminating a plurality of the electrode laminates according to the present disclosure, by providing such a configuration, adhesion between the peripheral portion of the current collector layer including the carbon coat layer and a sealing member such as resin can be improved, and thus a sealing property of the peripheral portion can be increased.

The current collector layer may be a positive electrode current collector layer and may be a negative electrode current collector layer.

### (Carbon Coat Layer)

In the present specification, the “first carbon coat layer” means a carbon coat layer having high absorptivity of laser light. Laser light absorptivity (%) of the first carbon coat layer is not particularly limited, and may be, for example, 50% or more, 60% or more, or 70% or more, and 100% or less, 90% or less, or 80% or less with respect to laser light having a wavelength of 970 nm.

In the present specification, the “second carbon coat layer” means a carbon coat layer having lower absorptivity of laser light than that of the first carbon coat layer. Laser light absorptivity (%) of the second carbon coat layer is not particularly limited, and may be, for example, 5% or more or 10% or more, and 40% or less, 35% or less, 30% or less, 25% or less, or 20% or less with respect to laser light having a wavelength of 970 nm.

Laser light absorptivity (−) can be measured by using an ultraviolet-visible-near infrared spectrophotometer (SolidSpec-3700DUV made by Shimadzu Corporation) by spectrophotometry.

The carbon coat layer can have laser light absorptivity adjusted by a surface being rubbed with a nonwoven fabric and the like, and can particularly have laser light absorptivity reduced by the surface being rubbed with a nonwoven fabric and the like.

The carbon coat layer includes at least a carbon particle, and may include the other binder, a dispersant, and the like. The binder can be referred to description of the electrode active material layer described below. Examples of the dispersant include, for example, carboxymethyl cellulose, and the like. A content of the carbon particle, the binder, the dispersant, and the like may be appropriately determined by performance required from the carbon coat layer, and the like.

A shape of the carbon coat layer is not particularly limited, and may be, for example, a sheet shape. A thickness of the carbon coat layer is not particularly limited, and may be, for example, 0.1 μm or more, 0.2 μm or more, 0.3 μm or more, or 0.5 μm or more, and 5.0 μm or less, 3.0 μm or less, 2.0 μm or less, or 1.0 μm or less.

### (Electric Conductor Layer)

A material of the electric conductor layer is not particularly limited, but a general electric conductor can be appropriately adopted as an electric conductor of a battery. When the current collector layer is the positive electrode current collector layer, examples of the material of the electric conductor layer can include, for example, Cu, Ni, Cr, Au, Pt, Ag, Al, Fe, Ti, Zn, Co, stainless steel, and the like. When the current collector layer is the negative electrode current collector layer, examples of the material of the electric conductor layer can include Cu, Ni, Cr, Au, Pt, Ag, Al, Fe, Ti, Zn, Co, stainless steel, a carbon sheet, or the like. The electric conductor layer may be acquired by applying the above-described metal to a metal foil or a base material by plating or vapor deposition.

A shape of the electric conductor layer is not particularly limited, and examples of the shape include, for example, a foil shape, a plate shape, a mesh shape, or the like. Particularly, the foil shape is preferable.

A thickness of the electric conductor layer is not particularly limited, and may be, for example, 0.1 μm or more or 1 μm or more, and 1 mm or less or 100 μm or less.

### <Electrode Active Material Layer>

The electrode active material layer may be a positive electrode active material layer and may be a negative electrode active material layer. When the current collector layer is the positive electrode current collector layer, the positive electrode active material layer is laminated on the first carbon coat layer. Further, when the current collector layer is the negative electrode current collector layer, the negative electrode active material layer is laminated on the first carbon coat layer.

A shape of the electrode active material layer is not particularly limited, and may be, for example, a sheet shape having a substantially plane surface. A thickness of the electrode current collector layer is not particularly limited, and may be, for example, 0.1 μm or more, 1 μm or more, 10 μm or more, or 100 μm or more, and 2.0 mm or less, 1.0 mm or less, or 0.5 mm or less.

The electrode active material layer includes at least a positive electrode active material or a negative electrode active material, and may further freely include a binder, a solid electrolyte, a conductive aid, and the like. The electrode active material layer may additionally include various additives. Each content of the positive electrode active material, the negative electrode active material, the solid electrolyte, the conductive aid, and the like in the electrode active material layer may be appropriately determined according to target battery performance.

### (Positive Electrode Active Material)

A material of the positive electrode active material is not particularly limited as long as the material can occlude and emit a lithium ion. The positive electrode active material may be, for example, lithium cobalt oxide (LiCoO₂), lithium nickel oxide (LiNiO₂), lithium manganese oxide (LiMn₂O₄), lithium nickel-cobalt-manganese oxide (NCM: LiCo_{1/3}Ni_{1/3}Mn_{1/3}O₂), lithium nickel-cobalt-aluminum oxide (LiNi_{0.8}(CoAl)_{0.2}O₂), a heteroelement substituent Li—Mn spinel of composition represented by Li₁₊ₓMn_{2-x-y}M_{y}O₄ (M is one or more kinds of metal elements selected from Al, Mg, Co, Fe, Ni, and Zn), and the like, but is not limited thereto.

The positive electrode active material is not particularly limited, but may include a covering layer. The covering layer is a layer having lithium ion conduction performance, having low reactivity with the positive electrode active material and the solid electrolyte, and containing a substance that does not flow even in contact with the active material and the solid electrolyte and can maintain a form of the covering layer. Specific examples of a material constituting the covering layer can include Li₄Ti₅O₁₂, Li₃PO₄, and the like in addition to LiNbO₃, but the material is not limited thereto.

A shape of the positive electrode active material is not particularly limited as long as the shape is a general shape as a positive electrode active material of a battery. The positive electrode active material may have, for example, a particulate shape. The positive electrode active material may be a primary particle, and may be a secondary particle acquired from aggregation of a plurality of primary particles. An average particle diameter D₅₀ of the positive electrode active material may be, for example, 1 nm or more, 5 nm or more, or 10 nm or more, and 500 μm or less, 100 μm or less, 50 μm or less, or 30 μm or less. Note that the average particle diameter D₅₀ is a particle diameter (median diameter) having an integrated value of 50% in a particle size distribution with reference to volume being obtained by laser diffraction/scattering.

### (Negative Electrode Active Material)

As the negative electrode active material, various substances whose potential (charge/discharge potential) at which a lithium ion is occluded and emitted is a potential lower than that of the positive electrode active material according to the present disclosure described above may be adopted. A material of the negative electrode active material is not particularly limited, and may be metal lithium, and may be a material that can occlude and emit a metal ion such as a lithium ion. Examples of the material that can occlude and emit a metal ion such as a lithium ion can include, for example, an alloy negative electrode active material, a carbon material, lithium titanate (Li₄Ti₅O₁₂), and the like, but the material is not limited thereto.

The alloy negative electrode active material is not particularly limited, and examples include, for example, an Si alloy negative electrode active material, an Sn alloy negative electrode active material, or the like. As the Si alloy negative electrode active material, there is silicon, a silicon oxide, a silicon carbide, a silicon nitride, a solid solution thereof, or the like. Further, the Si alloy negative electrode active material can include a metal element other than silicon, for example, Fe, Co, Sb, Bi, Pb, Ni, Cu, Zn, Ge, In, Sn, Ti, and the like. As the Sn alloy negative electrode active material, there is tin, a tin oxide, a tin nitride, a solid solution thereof, or the like. Further, the Sn alloy negative electrode active material can include a metal element other than tin, for example, Fe, Co, Sb, Bi, Pb, Ni, Cu, Zn, Ge, In, Ti, Si, and the like.

The carbon material is not particularly limited, and examples include, for example, hard carbon, soft carbon, graphite, and the like.

A shape of the negative electrode active material is not particularly limited, and may be a general shape as a negative electrode active material of a battery. The negative electrode active material may have, for example, a particulate shape or a sheet shape.

### (Binder)

A material of the binder is not particularly limited. The binder may be, for example, a material such as polyvinylidene difluoride (PVdF), butadiene rubber (BR), polytetrafluoroethylene (PTFE), and styrene-butadiene rubber (SBR), but is not limited thereto. The binder is not particularly limited, and only one kind may be used alone, or two or more kinds may be used in combination.

### (Solid Electrolyte)

A material of the solid electrolyte is not particularly limited, and may be, for example, a sulfide solid electrolyte, an oxide solid electrolyte, a polymer electrolyte, or the like.

Examples of the sulfide solid electrolyte include a sulfide-based amorphous solid electrolyte, a sulfide-based crystalline solid electrolyte, an argyrodite solid electrolyte, or the like, but the sulfide solid electrolyte is not limited thereto. Specific examples of the sulfide solid electrolyte can include: Li₂S—P₂S₅ series (Li₇P₃S₁₁, Li₃PS₄, Li₈P₂S₉, and the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, and the like), LiI—Li₂S—P₂O₅, LiI—Li₃PO₄—P₂S₅, Li₇₋ₓPS₆₋ₓClₓ, and the like; or a combination thereof, but the sulfide solid electrolyte is not limited thereto.

Examples of the oxide solid electrolyte can include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON), but the oxide solid electrolyte is not limited thereto.

The sulfide solid electrolyte and the oxide solid electrolyte may be glass and may be crystallized glass (glass ceramics).

Examples of the polymer electrolyte include polyethylene oxide (PEO), polypropylene oxide (PPO), a copolymer thereof, and the like, but the polymer electrolyte is not limited thereto.

### (Conductive Aid)

The conductive aid is not particularly limited. The conductive aid may be, for example, vapor growth carbon fiber (VGCF), acetylene black (AB), Ketjenblack (KB), carbon nanotube (CNT), carbon nanofiber (CNF), and the like, but the conductive aid is not limited thereto. The conductive aid may have, for example, a particulate shape or a fibrous shape, and a size of the conductive aid is not particularly limited. The conductive aid is not particularly limited, and only one kind may be used alone, or two or more kinds may be used in combination.

### <<Method for Manufacturing Electrode Laminate>

A method for manufacturing an electrode laminate according to the present disclosure includes:
laminating an electrode composite material slurry layer on at least a part of the first carbon coat layer; and
irradiating, with laser light, the electrode composite material slurry layer laminated on at least a part of the first carbon coat layer, and the adjacent region, drying the electrode composite material slurry layer, and forming an electrode active material layer.

According to the present disclosure, the method for manufacturing an electrode laminate in which a brittle fracture is less likely to occur can be provided.

The electrode active material layer is generally formed by coating, for example, a current collector layer with electrode composite material slurry, forming an electrode composite material slurry layer, and then drying the electrode composite material slurry layer.

When the electrode composite material slurry layer is dried by performing laser irradiation on the electrode composite material slurry, an adjacent region is also irradiated with the laser. When a surface of the current collector layer in the adjacent region has low laser light absorptivity, the current collector layer in the adjacent region is not overheated, and heat transfer to an end portion of the electrode composite material slurry layer is suppressed. Therefore, a drying speed of the end portion of the electrode composite material slurry layer is not increased, a crack is not generated in the formed electrode active material layer, and the electrode active material layer in which a brittle fracture is less likely to occur can be manufactured.

The method for manufacturing an electrode laminate according to the present disclosure includes laminating the electrode composite material slurry layer on at least a part of the first carbon coat layer. The electrode laminate and the first carbon coat layer can be referred to the description of the electrode laminate described above.

The electrode composite material slurry layer contains an electrode active material and a dispersion medium. The electrode active material can be referred to the description of the electrode active material layer described above. The electrode composite material slurry layer may further freely include a binder, a solid electrolyte, a conductive aid, and the like. The binder, the solid electrolyte, and the conductive aid can be referred to the description of the electrode active material layer described above.

With regard to the present disclosure, the “electrode composite material” means a composition that can constitute the electrode active material layer by being as it is or further containing the other component. Further, with regard to the present disclosure, the “electrode composite material slurry” means slurry that includes a dispersion medium in addition to the “electrode composite material” and can thus constitute the electrode active material layer by coating and drying.

The dispersion medium is not particularly limited, and may be, for example, a nonpolar solvent such as heptane, xylene, and toluene, and a polar solvent such as water, a tertiary amine solvent, an ether solvent, a thiol solvent, a ketone solvent (for example, diisobutyl ketone), and an ester solvent (for example, butyl butyrate).

A content of the dispersion medium is not particularly limited, and may be set in such a way that a solid content percentage of the electrode composite material slurry is 30% or more, 35% or more, 40% or more, 45% or more, or 50% or more, and is 80% or less, 75% or less, 70% or less, 65% or less, or 60% or less.

A method for laminating the electrode composite material slurry layer is not particularly limited, and may be a doctor blade method, a die coating method, a gravure coating method, a spray coating method, an electrostatic coating method, a bar coating method, and the like.

The method for manufacturing an electrode laminate according to the present disclosure includes irradiating, with laser light, the electrode composite material slurry layer laminated on at least a part of the first carbon coat layer, and the adjacent region, drying the electrode composite material slurry layer, and forming an electrode active material layer. The adjacent region and the electrode active material layer can be referred to the description of the electrode laminate described above.

A laser light source is not particularly limited, and may be, for example, a Yb fiber laser, a YAG laser, a carbon dioxide laser, and the like. A wavelength of the laser light may be, for example, 0.5 μm or more, 0.6 μm or more, 0.7 μm or more, 0.8 μm or more, or 0.9 μm or more, and 1.5 μm or less, 1.4 μm or less, 1.3 μm or less, 1.2 μm or less, or 1.1 μm or less.

An output of the laser light source is not particularly limited, and may be appropriately determined by an irradiation region of the laser light, an irradiation time of the laser light, and the like. An output of the laser light source may be, for example, 0.01 J/s or more, 0.1 J/s or more, 1 J/s or more, or 5 J/s or more, and 100 J or less, 50 J or less, or 10 J or less.

An irradiation time of the laser light is not particularly limited, and, for example, irradiation may be performed until a falling drying rate period of the electrode composite material slurry layer is reached. An irradiation time of the laser light may be, for example, 30 seconds or longer, 1 minute or longer, or 2 minutes or longer, and 30 minutes or shorter, 20 minutes or shorter, or 10 minutes or shorter.

A drying temperature is not particularly limited, and may be 50° C. or higher, 70° C. or higher, 90° C. or higher, 100° C. or higher, 110° C. or higher, or 120° C. or higher, and may be 200° C. or lower, 180° C. or lower, 160° C. or lower, 150° C. or lower, or 140° C. or lower.

### EXAMPLES

The present invention will be more specifically described below with Examples and Comparative Example, but the present invention is not limited thereto.

### <<Production of Electrode Laminate>>

Electrode composite material slurry was produced by measuring the amount of graphite as an electrode active material and a styrene-butadiene copolymer (SBR) as a binder in one second at a mass ratio of 97.9:2.1, and mixing the resultant with deionized water at a solid content percentage of 55%.

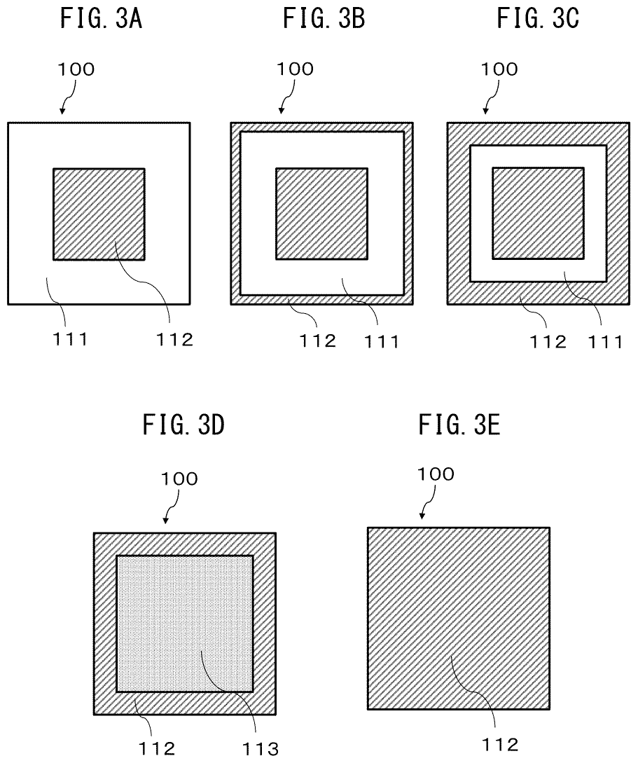

As in FIG. 3A, a current collector layer acquired by laminating, in a square shape, a first carbon coat layer having a side length of 100 mm on a central portion of a square aluminum foil surface having a side length of 200 mm as an electric conductor layer body was prepared as a current collector layer for production of Example 1.

As in FIG. 3B, a current collector layer acquired by laminating the first carbon coat layer having a width of 10 mm on an outer peripheral portion of the current collector layer for production of Example 1 was prepared as a current collector layer for production of Example 2.

As in FIG. 3C, a current collector layer acquired by laminating the first carbon coat layer having a width of 25 mm on the outer peripheral portion of the current collector layer for production of Example 1 was prepared as a current collector layer for production of Example 3.

As in FIG. 3D, a second carbon coat layer acquired by reducing laser light absorptivity of a rubbed portion of the first carbon coat layer by rubbing, with a nonwoven fabric, the first carbon coat layer present in a square region having a side length of 100 mm of a central portion of a surface of a current collector layer for production of Comparative Example 1 below was formed, and a current collector layer for production of Example 4 was prepared.

As in FIG. 3E, a current collector layer acquired by laminating the first carbon coat layer on an entire surface of the square aluminum foil surface having a side length of 200 mm as an electric conductor layer was prepared as the current collector layer for production of Comparative Example 1.

The laser light absorptivity having a wavelength of 970 nm of the first carbon coat layer was 0.5, laser light absorptivity having a wavelength of 970 nm of the second carbon coat layer was 0.4, and laser light absorptivity having a wavelength of 970 nm of the electric conductor layer was 0.05.

The central portion of the surface of the current collector layer for production of Examples 1 to 4 and Comparative Example 1 was coated with the electrode composite material slurry described above having a thickness of 400 μm in a square shape of a side length of 100 mm, and an electrode composite material slurry layer was formed. Then, a surface on a side on which the electrode composite material slurry layer was laminated in a square region having a side length of 200 mm in the presence of the current collector was irradiated with laser light having a wavelength of 970 nm for 60 seconds, the electrode composite material slurry layer was dried, and an electrode laminate of Examples 1 to 4 and Comparative Example 1 was produced.

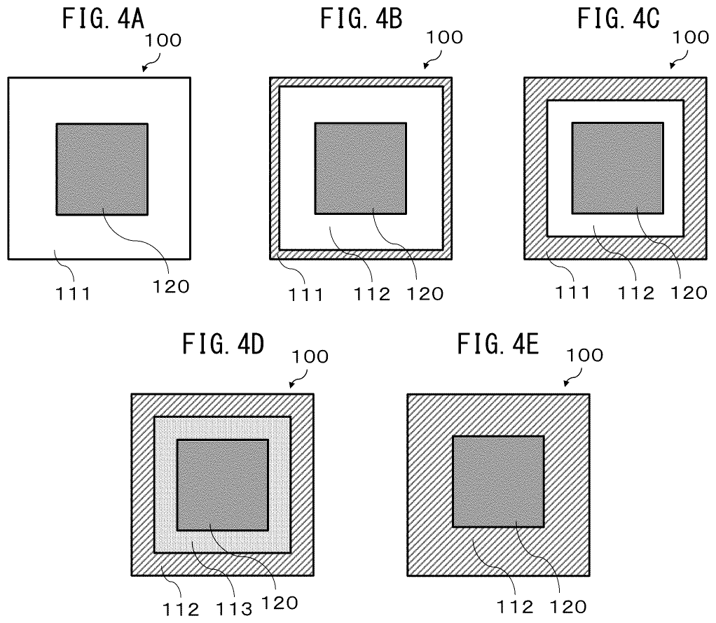

Herein, FIG. 4A corresponds to the electrode laminate of Example 1, FIG. 4B corresponds to the electrode laminate of Example 2, FIG. 4C corresponds to the electrode laminate of Example 3, FIG. 4D corresponds to the electrode laminate of Example 4, and FIG. 4E corresponds to the electrode laminate of Comparative Example 1.

### <<Brittleness Evaluation of Electrode Laminate>>

A drying situation within 10 mm from an end portion of an electrode active material layer included in the electrode laminate of Examples 1 to 4 and Comparative Example 1 and generation of a crack by visual inspection were evaluated. Note that, when a crack was generated, a drying time since drying of the electrode composite material slurry started until the crack was generated was measured. Note that a time since irradiation of laser light started until the electrode composite material slurry layer reached a falling drying rate period was set as a drying time.

Each of the evaluation results was illustrated in Table 1.

TABLE 1

| | CURRENT COLLECTOR | | | | | | |
|---|---|---|---|---|---|---|---|
| | LAYER | | BRITTLE EVALUATION OF | | BRITTLE EVALUATION | | |
| | LASER | | CENTRAL PORTION | | OF END PORTION | | |
| | LIGHT | WIDTH | | PRESENCE | | PRESENCE | |
| | ABSORPTIVITY | OF | | OR | | OR | OCCURRENCE |
| | (—) | ADJACENT | DRYING | ABSENCE | DRYING | ABSENCE | TIME |
| | IN ADJACENT | REGION | COMPLETION | OF | COMPLETION | OF | OF |
| | REGION | (mm) | TIME (s) | CRACKING | TIME (s) | CRACKING | CRACKING (s) |
| EXAMPLE 1 | 0.05 | 50 | 60 | ABSENCE | 60 | ABSENCE | — |
| EXAMPLE 2 | 0.05 | 40 | 60 | ABSENCE | 60 | ABSENCE | — |
| EXAMPLE 3 | 0.05 | 25 | 60 | ABSENCE | 60 | PRESENCE | 45 |
| EXAMPLE 4 | 0.40 | 25 | 60 | ABSENCE | 60 | PRESENCE | 40 |
| COMPARATIVE | 0.50 | 25 | 60 | ABSENCE | 60 | PRESENCE | 30 |
| EXAMPLE 1 | | | | | | | |

It can be understood from Examples 1 to 3 and Comparative Example 1 in Table 1 that, since the electric conductor layer was exposed without the first carbon coat layer in the adjacent region, the current collector layer in the adjacent region was not overheated, excessive heat transfer to the end portion of the electrode composite material slurry layer was suppressed, cracking was less likely to occur in the formed electrode active material layer, and toughness was increased. Further, it can be understood from Example 4 and Comparative Example 1 that cracking was less likely to occur by disposing the second carbon coat layer having lower laser light absorptivity than that of the first carbon coat layer in the adjacent region, and thus heat transfer to the end portion of the electrode composite material slurry layer was suppressed.

### REFERENCE SIGNS LIST

100 Electrode laminate
110 Current collector layer
111 Electric conductor layer
112 First carbon coat layer
113 Second carbon coat layer
120 Electrode active material layer
200 Adjacent region

What is claimed is:

1. An electrode laminate comprising:
a current collector layer; and an electrode active material layer laminated on a part of the current collector layer, wherein
the current collector layer includes an electric conductor layer, and a first carbon coat layer laminated in at least a part of a region of the electric conductor layer,
the electrode active material layer is laminated on at least a part of the first carbon coat layer, and,
in an adjacent region being adjacent to the electrode active material layer, the current collector layer does not include the first carbon coat layer, or includes a second carbon coat layer having lower absorptivity of laser light having a wavelength of 970 nm than that of the first carbon coat layer.

2. The electrode laminate according to claim 1, wherein the electrode active material layer is laminated on only a part of the first carbon coat layer.

3. The electrode laminate according to claim 1, wherein the first carbon coat layer on which the electrode active material layer is not laminated is disposed on a peripheral portion of the current collector layer.

4. The electrode laminate according to claim 1, wherein, in the adjacent region, absorptivity of laser light having a wavelength of 970 nm of the current collector layer is 40% or less.

5. A method for manufacturing the electrode laminate according to claim 1 comprising:
laminating an electrode composite material slurry layer on at least a part of the first carbon coat layer; and
irradiating, with laser light, the electrode composite material slurry layer laminated on at least a part of the first carbon coat layer, and the adjacent region, drying the electrode composite material slurry layer, and forming an electrode active material layer.
